(19) United States
(12) Patent Application Publication
(10) Pub. No.: US 2014/0156714 A1
(43) Pub. Date: Jun. 5, 2014

(54) DISTRIBUTED FILE SYSTEM PROCESSING APPARATUS AND METHOD, AND STORAGE MEDIA STORING THE SAME

(71) Applicant: LG CNS CO., LTD., (US)

(72) Inventors: Kyo Tack Kim, Seoul (KR); Seok Keun Oh, Seoul (KR); Sang Hyun Yun, Seoul (KR); Su Yeon Lee, Seoul (KR); Joo Youl Lee, Seoul (KR)

(73) Assignee: LG CNS CO., LTD., Seoul (KR)

(21) Appl. No.: 13/864,577

(22) Filed: Apr. 17, 2013

(30) Foreign Application Priority Data
Nov. 30, 2012 (KR) 10-2012-0138476

(51) Int. Cl. G06F 17/30

(52) U.S. Cl. CPC G06F 17/30194
USPC 707/827

(57) ABSTRACT

Disclosed is a distributed file system processing apparatus that includes at least one Service Configuration and Management (SCM) client unit including a distributed file system, the distributed file system set by setting information defined by a specific regulation, a SCM server unit configured to manage each setting item in the distributed file system, per version, through a setting environment database and configured to generate setting information in the setting environment database according to the specific regulation, and at least one SCM agent unit configured to receive the generated setting information from the SCM server unit to provide the received setting information to the at least one SCM client unit.

### CROSS-REFERENCE TO RELATED APPLICATION

This application claims priority under 35 U.S.C. §119 to Korean Patent Application No. 10-2012-0138476, filed on Nov. 30, 2012, in the Korean Intellectual Property Office, the contents of which is incorporated herein by reference.

### BACKGROUND OF THE INVENTION

1. Field of the Invention

The present invention relates to a distributed file system processing technique and, more particularly, to a distributed file system processing apparatus and method a distributed file system and storage media storing the same.

2. Background of the Invention

A distributed file system hierarchically collects and manages distributed data in a single path or a single filename which are stored in a plurality of computers.

The Korean Patent Laid Open Publication No. 10-1998-0059238 relates to manage a method to a distributed database, when the managing command is inputted from the managing circuit, setting and monitoring for the database in a board involved being transmitted the managing command data; and outputting a result data of the database, through the master board.

The Korean Patent Laid Open Publication No. 10-1995-0069688 relates to a method for auto updating to software program in network structure, a new software program without a previous version-up table, it is judged whether a version code of the version-up table downloaded is a specific code value set up. After that, it is determined whether to download the software program. It is determined whether to update the new software program according to an updating system classification code of the version-up table.

Such prior arts disclose technologies that may provide recent configurations in computer system, through communication network, connected with each other or may automatically update the computer system with the recent configurations.

### SUMMARY OF THE INVENTION

Embodiments of the present invention provide a distributed file system processing apparatus including at least one Service Configuration and Management (SCM) client unit including a distributed file system, the distributed file system set by setting information defined by a specific regulation, a SCM server unit configured to manage each setting item in the distributed file system per version through a setting environment database and configured to generate setting information in the setting environment database according to the specific regulation and at least one SCM agent unit configured to receive the generated setting information from the SCM server unit to provide the received setting information to the at least one SCM client unit.

A first aspect of the present invention provides a distributed file system processing apparatus comprising: at least one service configuration and management (SCM) client unit including a distributed file system, the distributed file system set by setting information defined by a specific regulation; a SCM server unit configured to manage each setting item in the distributed file system per version through a setting environment database and configured to generate setting information in the setting environment database according to the specific regulation; and at least one SCM agent unit configured to receive the generated setting information from the SCM server unit to provide the received setting information to the at least one SCM client unit.

A second aspect of the present invention provides a distributed file system processing method performed by a distributed file system processing apparatus, the apparatus including at least one service configuration and management (SCM) client unit, a SCM agent unit and a SCM server unit, the method comprising: managing, through the SCM server unit, each setting item in the distributed file system of SCM client unit per version through the a setting environment database and generating each of a most recent version setting item in the setting environment database according to the specific regulation; and setting, through the SCM agent unit, a distributed file system in the SCM client unit provides the generating setting information from the SCM server unit to the SCM client unit.

A third aspect of the present invention provides a storage media storing a computer program performed by a distributed file system processing apparatus, the distributed file system processing apparatus including at least one service configuration and management (SCM) client unit, a SCM agent unit and a SCM server unit, the computer program comprising: a function of managing, through the SCM server unit, each setting item in the distributed file system of SCM client unit per version through a setting environment database and generating each of a most recent version setting item in the setting environment database according to the specific regulation; and a function of setting, through the SCM agent unit, a distributed file system in the SCM client unit provides the generating setting information from the SCM server unit to the SCM client unit.

### BRIEF DESCRIPTION OF THE DRAWINGS

The above and other objects and features of the present invention will become apparent from the following description of preferred embodiments given in conjunction with the accompanying drawings, in which:

FIG. 1 is a diagram illustrating a distributed file system processing apparatus according to an example embodiment of the present invention.

FIG. 2 is a flowchart illustrating an operation of a distributed file system in FIG. 1.

FIGS. 3, 4a and 4b are diagrams illustrating procedures for controlling a setting item to be applied to a distributed file system in a SCM server unit in FIG. 1.

FIG. 5 is a diagram illustrating procedures for updating a setting item in a SCM server unit in FIG. 1.

FIG. 6 is a diagram illustrating an operation of a SCM server unit and a SCM client unit in FIG. 1.

The drawings are not necessarily to scale. The drawings are merely representations, not intended to portray specific parameters of the invention. The drawings are intended to depict only typical embodiments of the invention, and therefore should not be considered as limiting in scope. In the drawings, like numbering represents like elements.

### DETAILED DESCRIPTION OF THE EMBODIMENTS

Explanation of the present invention is merely an embodiment for structural or functional explanation, so the scope of the present invention should not be construed to be limited to the embodiments explained in the embodiment. That is, since the embodiments may be implemented in several forms without departing from the characteristics thereof, it should also be understood that the above-described embodiments are not limited by any of the details of the foregoing description, unless otherwise specified, but rather should be construed broadly within its scope as defined in the appended claims. Therefore, various changes and modifications that fall within the scope of the claims, or equivalents of such scope are therefore intended to be embraced by the appended claims.

Terms described in the present disclosure may be understood as follows.

While terms such as “first” and “second,” etc., may be used to describe various components, such components must not be understood as being limited to the above terms. The above terms are used only to distinguish one component from another. For example, a first component may be referred to as a second component without departing from the scope of rights of the present invention, and likewise a second component may be referred to as a first component.

It will be understood that when an element is referred to as being “connected to” another element, it can be directly connected to the other element or intervening elements may also be present. In contrast, when an element is referred to as being “directly connected to” another element, no intervening elements are present. In addition, unless explicitly described to the contrary, the word “comprise” and variations such as “comprises” or “comprising,” will be understood to imply the inclusion of stated elements but not the exclusion of any other elements. Meanwhile, other expressions describing relationships between components such as “˜between”, “immediately˜between” or “adjacent to ˜” and “directly adjacent to ˜” may be construed similarly.

Singular forms “a”, “an” and “the” in the present disclosure are intended to include the plural forms as well, unless the context clearly indicates otherwise. It will be further understood that terms such as “including” or “having,” etc., are intended to indicate the existence of the features, numbers, operations, actions, components, parts, or combinations thereof disclosed in the specification, and are not intended to preclude the possibility that one or more other features, numbers, operations, actions, components, parts, or combinations thereof may exist or may be added.

Identification letters (e.g., a, b, c, etc.) in respective steps are used for the sake of explanation and do not described order of respective steps. The respective steps may be changed from a mentioned order unless specifically mentioned in context. Namely, respective steps may be performed in the same order as described, may be substantially simultaneously performed, or may be performed in reverse order.

In describing the elements of the present invention, terms such as first, second, A, B, (a), (b), etc., may be used. Such terms are used for merely discriminating the corresponding elements from other elements and the corresponding elements are not limited in their essence, sequence, or precedence by the terms.

In the embodiments of the present invention, the foregoing method may be implemented as codes that can be read by a processor in a program-recorded medium. The processor-readable medium may include any types of recording apparatus in which data that can be read by a computer system is stored. The processor-readable medium may include a ROM, a RAM, a CD-ROM, a magnetic tape, a floppy disk, an optical data storage apparatus, and the like. The processor-readable medium also includes implementations in the form of carrier waves or signals (e.g., transmission via the Internet). The computer-readable recording medium may be distributed over network-coupled computer systems so that the computer-readable code may be stored and executed in a distributed fashion.

In the foregoing exemplary system, the methods are described based on the flow chart as sequential steps or blocks, but the present invention is not limited to the order of the steps and some of them may be performed in order different from the order of the foregoing steps or simultaneously. Also, a skilled person in the art will understand that the steps are not exclusive but may include other steps, or one or more steps of the flow chart may be deleted without affecting the scope of the present invention.

The terms used in the present application are merely used to describe particular embodiments, and are not intended to limit the present invention. Unless otherwise defined, all terms used herein, including technical or scientific terms, have the same meanings as those generally understood by those with ordinary knowledge in the field of art to which the present invention belongs. Such terms as those defined in a generally used dictionary are to be interpreted to have the meanings equal to the contextual meanings in the relevant field of art, and are not to be interpreted to have ideal or excessively formal meanings unless clearly defined in the present application.

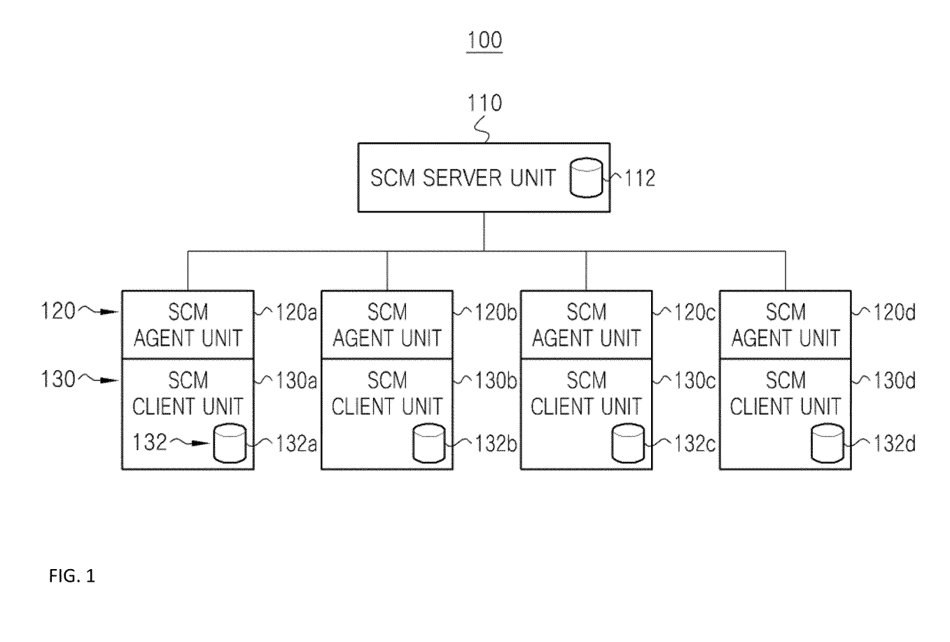

FIG. 1 is a diagram illustrating a distributed file system processing apparatus according to an example embodiment of the present invention.

Referring to FIG. 1, a distributed file system processing apparatus 100 includes a Service Configuration and Management (SCM) server unit 110, a SCM agent unit 120 and a SCM client unit 130.

In one embodiment, the SCM server unit 110 is connected to the SCM agent unit 120 and the SCM client unit 130 through a network (e.g., Internet). In other embodiments, the SCM agent unit 120 and the SCM client unit 130 may be implemented as a physically unified hardware.

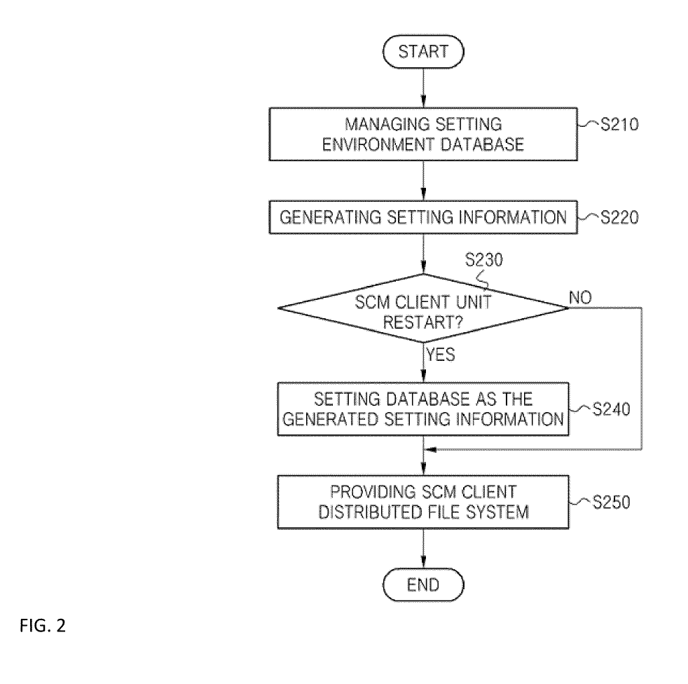

The SCM server unit 110 corresponds to a front-end server for a request or response to a distributed file system and manages the SCM client unit 130 through a setting environment database 112. In one embodiment, the SCM server unit 110 operates an independent database system including a database engine and a database. The database engine processes a submitted command by an operator and determines whether setting information is distributed or not. A detailed operation of the SCM server unit 110 is described with references to FIGS. 2 through 6.

The SCM agent unit 120 connects the SCM server unit 110 and at least one SCM client unit 130 to cause the SCM server unit 110 to control the SCM client unit 130 through the setting information or to cause the SCM client unit 130 to report its own status to the SCM server unit 110.

For example, there may be one-to-one correspondence between the SCM agent unit 120 and the SCM client 130.

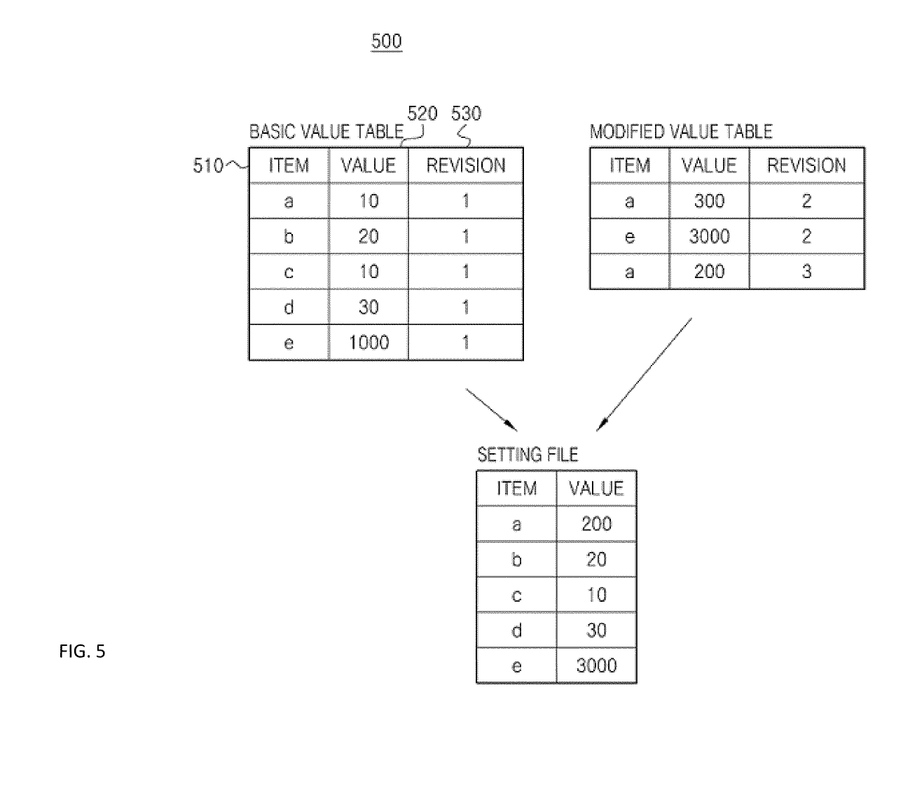

In one embodiment, the SCM agent unit 120 may be implemented as a daemon process in the SCM client unit 130. A detailed operation of the SCM agent 120 is described with references to FIGS. 2 and 5.

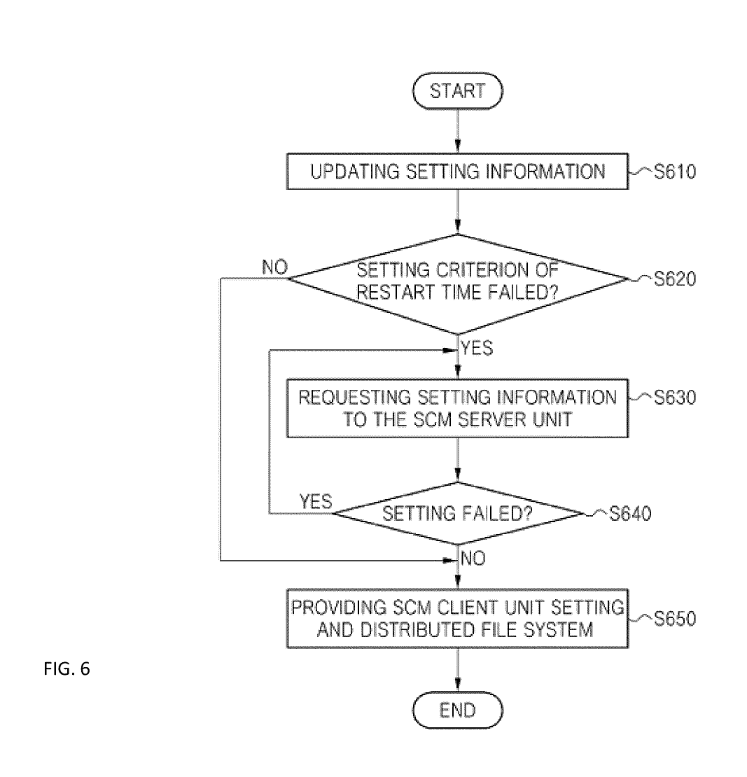

The SCM client unit 130 may correspond to a back-end computing device in the distributed file system 132 and may control the distributed file system 132 through the setting information received from the SCM server unit 110. Herein, the distributed file system 132 may correspond to a repository storing data according to a purpose thereof. In one embodiment, the SCM client unit 130 may form a Hadoop distributed file system. The Hadoop distributed file system is implemented as a Java-based software framework and analyzes mass data in a plurality of distributed computers unlike a relational database. A detailed operation of the SCM client unit 130 is described with reference to FIG. 6.

FIG. 2 is a flowchart illustrating an operation of a distributed file system in FIG. 1.

The SCM server unit 110 manages each of setting item, per version, to be applied to the distributed file system 132 of the SCM client unit 130 through the setting environment database 112 (Step S210). The setting environment database 112 corresponds to a repository a storing the setting environment (i.e., setting information) of the distributed file system 132 and the setting environment of the distributed file system 132 may include at least one of entire setting information about the SCM client 130 and setting information about a specific SCM client unit 130a.

The SCM server unit 110 generates each of the most recent version setting item in the setting environment database 112 according to a specific regulation as the setting information (Step S220). Herein, the specific regulation may indicate a formal grammar commonly interpreted by the SCM server unit 110, the SCM agent unit 120, and SCM client unit 130, and for example, may be implemented as a XML (eXtensible Markup Language).

The SCM server unit 110 resets the distributed file system 132 of the SCM client unit 130 as a corresponding setting information when the distributed file system file system 132 of the SCM client unit 130 starts or restarts (Step S240). Herein, the SCM agent unit 120 transmits the setting information between the SCM server unit 110 and the SCM client unit 130. In one embodiment, the SCM server unit 110 compulsorily restarts the distributed file system 132 when the SCM client unit 130 is idle during a specific time to apply to a most recent version setting item. Herein, the idle status may indicate a state that does not perform any procedures in a corresponding device. Meanwhile, the specific time may be calculated as a following mathematical equation:

Tₙ₊₁=fn(α)*Tₙ(0.1≦fₙ(α)≦10),

wherein Tₙ: duration time of an n-th idle state, and

wherein fₙ(α): function defined as a number of input-output data generation(α) of the SCM client unit 130 at the duration time of an n-th idle state

In other words, the specific time can be increased according to input by a user and can be decreased according to output by a user.

The SCM client unit 130 provides the resetting distributed file system when a set will be finished a setting information (Step S250).

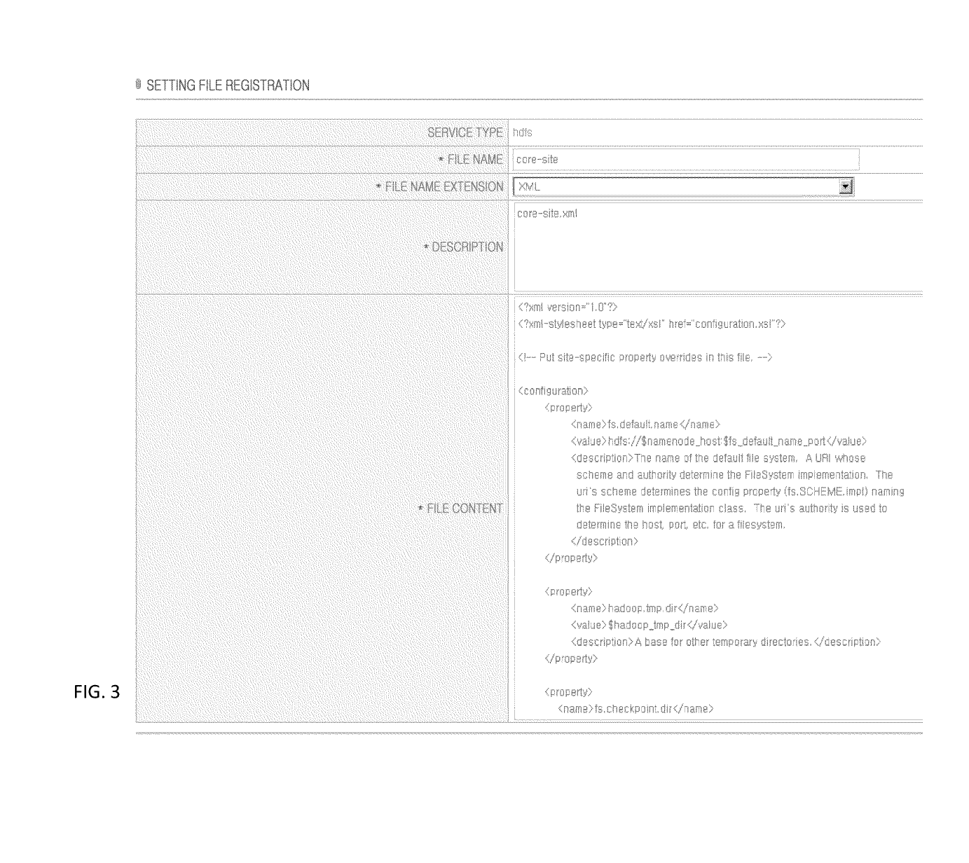

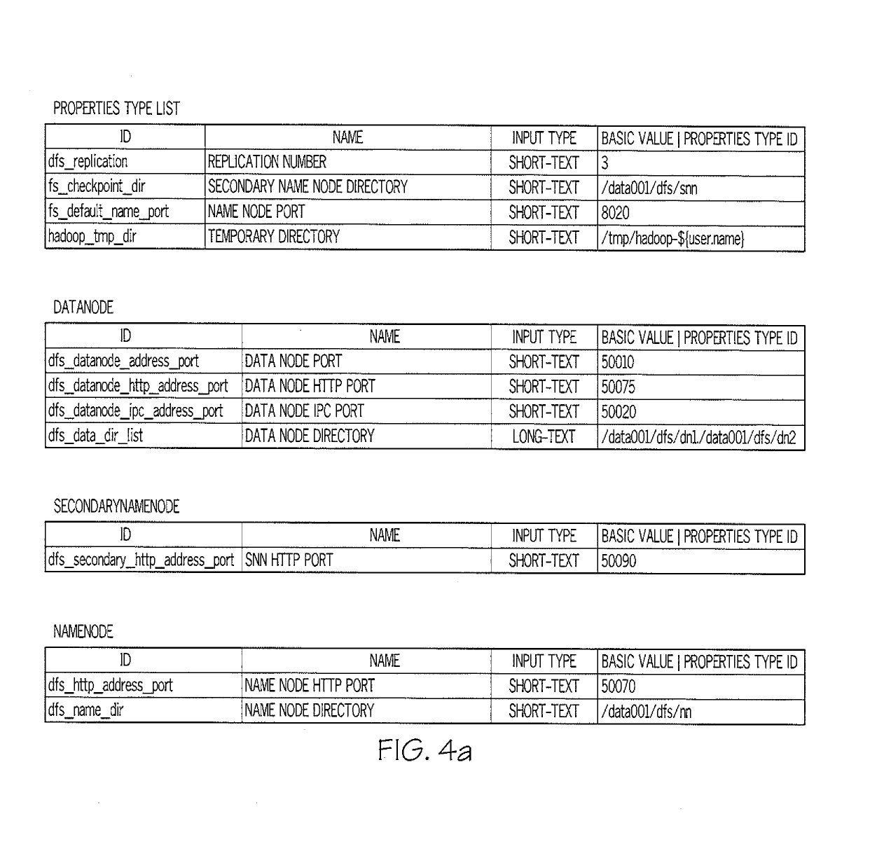

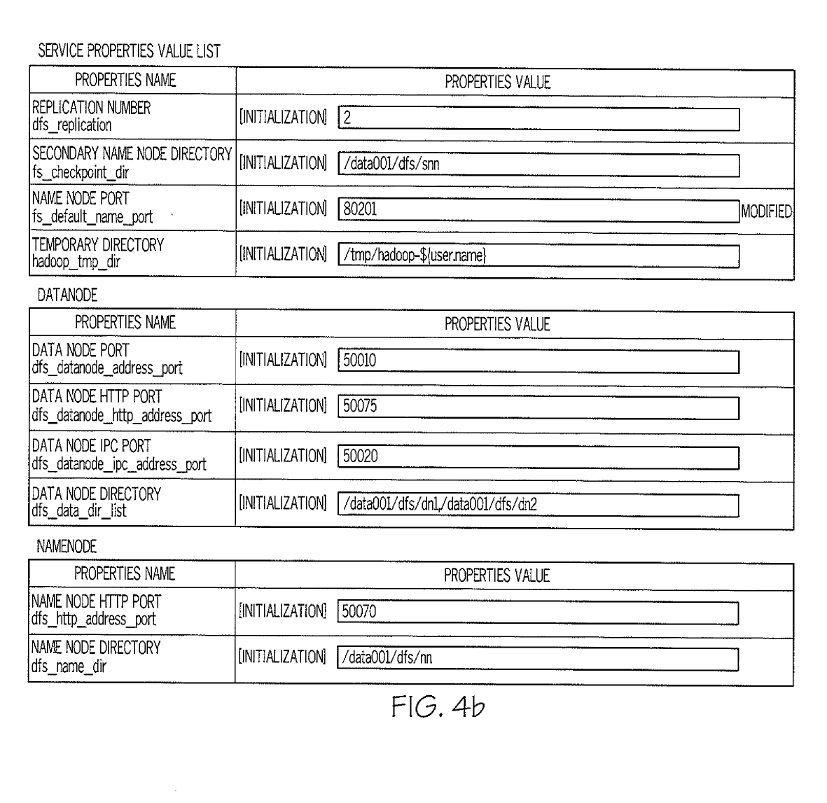

FIGS. 3, 4a and 4b are diagrams illustrating procedures for controlling a setting item to be applied to a distributed file system in a SCM server unit in FIG. 1.

As illustrated in FIG. 3, the SCM server unit 110 may set a setting item stored in the setting environment database 112 through a single file (e.g., XML file). In other words, the setting item may be inputted as a file by a system operator.

As illustrated in FIGS. 4a and 4b, the SCM server unit 110 may receive each of setting items stored in the setting environment database 112 through a user interface. Such setting items may be manually inputted by a system operator but may be set by default as values recommended in the SCM agent unit 120.

Although the setting items are not explicitly illustrated in FIGS. 3 and 4, the setting items may include at least one of a number of Replication, a Secondary Name Node Directory, a Name Node Port, a Temporary Directory, a Data Node Port, a Data Node HTTP Port, a Data Node InterProcessor Communication (IPC) Port, a Data Node Directory, a Name Node HTTP Port and a Name Node Directory.

FIG. 5 is a diagram illustrating procedures for updating a setting item in a SCM server unit in FIG. 1.

The SCM server unit 110 includes the setting environment database 112 and the setting environment database 112 may include a setting item name 510, a setting item value 520 and a revision value 530 for each of a setting item 500.

The SCM server unit 110 may add, change or may delete the setting item name 510 in the setting environment database 112 and when the setting item name 510 is deleted, the SCM server unit 110 may delete a corresponding setting item.

The SCM server unit 110 may change a value of the setting item 520 in the setting environment database 112 and when the setting item value 520 changes, may also change the revision value 530. Herein, the revision value 530 may automatically change in the SCM server unit 100.

Meanwhile, the SCM server unit 110 detects a change in each of the setting item 500 to update a setting item history per corresponding setting item. Namely, the SCM server unit 110 may retain a recent version setting item through the setting environment database 112 and may track of a change in each setting item in the setting item history.

The SCM server unit 110 may provide recent or previous version setting information for setting the distributed file system 132 in SCM client unit 130 through the setting item history.

In one embodiment, the SCM client unit 130 tests a performance of the distributed file system 132 to request an optimum one of previous version property items in the setting item history. Herein, a performance test of the distributed file system 132 may be determined based on an expected output value about a specific input value and an actual output value of the distributed file system 132 and in one embodiment, the SCM client unit 130 may determine, as an optimum property item, a property item when the difference between the expected output value and the actual output value is smallest. The SCM client unit 130 may request the optimum property item to the SCM server unit 110.

When a request for a previous version property item is received from a specific SCM client unit 130a, the SCM server unit 110 may determine whether the optimum one of the previous version property items is also applied to other SCM client unit 130b. The SCM client unit 130 may include the distributed file system 132 with same or similar operation characteristics and may optimize a performance of the distributed file system 132 through same or similar setting information. Therefore, when the optimum one of the previous version property items is transmitted to the specific SCM client unit 130a, the SCM server unit 110 determines whether the optimum one may also be applied to other SCM client unit 130b that operates in a same or similar way and if then, transmits the optimum one.

In one embodiment, when an error occurs in the distributed file system 132a in spite of setting the distributed file system 132a in a specific client unit 130a through a recent version setting information, the SCM server unit 110 may restore a corresponding setting item into a previous version setting item through the setting item history. Namely, herein, a problem may occur because of improper setting information and the SCM server unit 110 may solve the problem to restore the corresponding setting item into a previous version setting item through the setting item history.

In one embodiment, the SCM agent unit 120 may transmit, at regular intervals, whether the SCM client unit 130 normally operates or not to the SCM server unit 110 and errors in the SCM client unit 130 may include a hardware error and a distributed file system error. Herein, the distributed file system error may indicate an abnormal state for CRUD (Create, Read, Update and Delete) operation of the distributed file system and the hardware error may indicate all errors except the distributed file system error.

The SCM server unit 110 may receive whether the SCM client unit 130 normally operates or not from the SCM agent unit 120 to analyze a current status of the SCM client unit 130 and may control an operation of the SCM client unit 130.

In one embodiment, the SCM agent unit 120 may determine the regular interval by a following mathematical equation:

Tₙ₊₁=(fₙ(α)+g1˜n(β))*Tₙ(0.1≦fₙ(α)+g1˜n(β)≦10),

wherein Tₙ: an n-th transmission cycle,

wherein fₙ(α): function defined as a number of error generation(α) in a hardware of the SCM client unit at an n-th transmission cycle, and

wherein g_{1˜n}(β): function defined as a number of error generation(β) in the distributed file system of the SCM client unit from a first transmission cycle to the n-th transmission cycle.

Herein, fₙ(α) and g₁₋ₙ(β) correspond to a determined function according to the operation of the SCM client unit 130. Herein, the above mathematical equation indicates that the larger is a value of fₙ(α)+g₁₋ₙ(β) the smaller is a number of error in the SCM client unit in a corresponding interval. The SCM agent unit 120 extends a next transmission cycle when a value of fₙ(α)+g_{1˜n}(β) is larger and this may improve transmission efficiency.

FIG. 6 is a diagram illustrating an operation of a SCM server unit and a SCM client unit in FIG. 1.

The SCM server unit 110 continually updates setting information until the distributed file system 132 of the SCM client unit 130 restarts (Step S610) to set the most recent version setting item to the distributed file system 132 in a restart timing point. Therefore, the SCM server unit 110 sets the most recent version setting item to the distributed file system 132 not to set the distributed file system 132 of the SCM client unit 130 several times.

When a setting for the distributed file system through the most recent version setting item fails (Step S620), the SCM client unit 130 may request setting information generated based on a previous version setting item in the setting environment database 112 of the SCM server unit 110 (Step S630). When an error unexpectedly occurs in spite of setting the distributed file system 132 of the SCM client 130 through the most recent version one of setting information continually updated by the SCM server unit 110, the SCM client unit 130 may request the previous version setting information to maintain the distributed file system 132 in an operable state.

The SCM client unit 130 repeats a corresponding request until a setting for the distributed file system 132 succeeds to set the distributed file system 132 into setting information generated based on a corresponding version setting item (Step S630 and S640). The SCM client unit 130 and the SCM server unit 110 repeat a corresponding requesting and setting to maintain the distributed file system 132 in an operable state.

The SCM client unit 130 provides the distributed file system 132 when the SCM server unit 110 finishes a setting of the SCM client unit 130 (Step S650).

The SCM server unit 110 may store a current version setting information of a corresponding distributed file system 132 into the setting environment database 112 when a corresponding setting succeeds. The SCM server unit 110 may reflect the stored setting information after a later setting information change may be performed.

Although this document provides descriptions of preferred embodiments of the present invention, it would be understood by those skilled in the art that the present invention can be modified or changed in various ways without departing from the technical principles and scope defined by the appended claims.

What is claimed is:

1. A distributed file system processing apparatus comprising:
at least one service configuration and management (SCM) client unit including a distributed file system, the distributed file system set by setting information defined by a specific regulation;
a SCM server unit configured to manage each setting item in the distributed file system per version through a setting environment database and configured to generate, as the setting information, each of most recent version setting information in the setting environment database according to the specific regulation; and
at least one SCM agent unit configured to receive the generated setting information from the SCM server unit to provide the received setting information to the at least one SCM client unit.

2. The distributed file system processing apparatus of claim 1, wherein the SCM server unit detects a change in each of the setting item to update a setting item history per the setting item.

3. The distributed file system processing apparatus of claim 2, wherein the SCM server unit restores the corresponding setting item to a previous version through the setting item history when an error occurs in the distributed file system of a specific SCM client unit.

4. The distributed file system processing apparatus of claim 3, wherein the SCM agent unit transmits at regular intervals whether the specific SCM client unit normally operates to the SCM sever unit.

5. The distributed file system processing apparatus of claim 4, wherein the regular intervals are determined by the following mathematical equation:
Tₙ₊₁=(fₙ(α)+g_{1˜n}(β))*Tₙ(0.1≦fₙ(α)+g_{1˜n}(β)≦10),
wherein Tₙ: an n-th transmission cycle,
wherein fₙ(α): function defined as a number of error generation(α) in a hardware of the SCM client unit at an n-th transmission cycle, and
wherein g_{1˜n}(β): function defined as a number of error generation(β) in the distributed file system of the SCM client unit from a first transmission cycle to the n-th transmission cycle.

6. The distributed file system processing apparatus of claim 3, wherein the SCM server unit continually updates the generated setting information until a corresponding distributed file system restarts to set the corresponding distributed file system as a setting item of a most recent version of a setting item at the restart point.

7. The distributed file system processing apparatus of claim 6, wherein the SCM client unit requests, to the SCM server unit, setting information generated based on setting item of previous version in the setting environment database when the setting failed.

8. The distributed file system processing apparatus of claim 7, wherein the SCM client unit repeats the request to set the corresponding distributed file system as setting information generated based on a corresponding version setting item until the setting succeeds.

9. The distributed file system processing apparatus of claim 8, wherein the SCM server unit stores a current version of the corresponding distributed file system in the setting environment database when the setting succeeds.

10. The distributed file system processing apparatus of claim 2, wherein the SCM client unit tests a performance of the distributed file system to request a properties item of the best previous version in the setting item history.

11. The distributed file system processing apparatus of claim 10, wherein the SCM server unit determines whether a properties item of the best previous version is applied to other SCM client unit when the request of the previous version received.

12. The distributed file system processing apparatus of claim 1, wherein the SCM server unit compulsorily restarts the distributed file system to apply to a most recent version setting item when the SCM client unit is idle during a specific time.

13. A distributed file system processing method performed by a distributed file system processing apparatus, the apparatus including at least one service configuration and management (SCM) client unit, a SCM agent unit and a SCM server unit, the method comprising:
managing, through the SCM server unit, each setting item in the distributed file system of SCM client unit per version through a setting environment database, and generating each of a most recent version setting item in the setting environment database according to the specific regulation; and
setting, through the SCM agent unit, a distributed file system in the SCM client unit to provide the generating setting information from the SCM server unit to the SCM client unit.

14. The distributed file system processing method of claim 13, further comprising managing a setting item of the distributed file system per version through the setting environment database to detect a change in each of the setting item to update a setting item history per the setting item.

15. The distributed file system processing method of claim 10, further comprising generating the setting information according to the specific regulation to restore the corresponding setting item to a previous version through the setting item history when an error occurs in the distributed file system of a specific SCM client unit.

16. The distributed file system processing method of claim 15, further comprising setting a distributed file system in the specific SCM client unit to transmit at regular intervals whether the specific SCM client unit normally operates to the SCM sever unit.

17. The distributed file system processing method of claim 16, wherein the regular intervals are determined by the following mathematical equation:
Tₙ₊₁=(fₙ(α)+g_{1˜n}(β))*Tₙ(0.1≦fₙ(α)+g_{1˜n}(β)≦10),
wherein Tₙ: an n-th transmission cycle,
wherein fₙ(α): function defined as a number of error generation(α) in a hardware of the SCM client unit at an n-th transmission cycle, and
wherein g_{1˜n}(β): function defined as a number of error generation(β) in the distributed file system of the SCM client unit from a first transmission cycle to the n-th transmission cycle.

18. The distributed file system processing method of claim 15, further comprising setting the distributed file system in the specific SCM client unit to update the generated setting information until a corresponding distributed file system restarts to set the corresponding distributed file system as setting item of a most recent version of a setting item at the restart point.

19. The distributed file system processing method of claim 18, further comprising setting the distributed file system in the specific SCM client unit to request the SCM server unit, to the SCM server unit, setting information generated based on the setting item of the previous version in the setting environment database when the setting failed.

20. The distributed file system processing method of claim 19, further comprising setting the distributed file system in the specific SCM client unit to repeat the request to set the corresponding distributed file system as setting information generated based on a corresponding version setting item until the setting succeeds.

21. The distributed file system processing method of claim 20, further comprising managing each of a setting item of the distributed file system per version through a setting environment database to store a current version of the corresponding distributed file system in the set environment database when the setting succeeds.

22. The distributed file system processing method of claim 14, further comprising setting the distributed file system in the specific SCM client unit to test a performance of the distributed file system to request a properties item of the best previous version in the setting item history.

23. The distributed file system processing method of claim 22, further comprising managing each of the setting item of the distributed file system per version through the setting environment database to determine whether a properties item of the best previous version is applied to other SCM client unit when the request of the previous version received.

24. The distributed file system processing method of claim 13, further comprising setting the distributed file system in the specific SCM client unit with the generated setting information to compulsorily restart the distributed file system to apply to a most recent version setting item when the SCM client unit is idle during a specific time.

25. A storage media storing a computer program performed by a distributed file system processing apparatus, the distributed file system processing apparatus including at least one service configuration and management (SCM) client unit, a SCM agent unit and a SCM server unit, the computer program comprising:
a function of managing, through the SCM server unit, each setting item in the distributed file system of SCM client unit per version through a setting environment database and generating each of a most recent version setting item in the setting environment database according to the specific regulation; and
a function of setting, through the SCM agent unit, a distributed file system in the SCM client unit to provide the generating setting information from the SCM server unit to the SCM client unit.
